(19) United States
(12) Patent Application Publication
(10) Pub. No.: US 2010/0262567 A1
(43) Pub. Date: Oct. 14, 2010

(54) Puzzle-Based Fundraising Method Implemented with Trading Cards

(76) Inventor: Anne Berry, Warrington, PA (US)

Correspondence Address: Michael Crilly, Esquire, Law Offices of Michael Crilly, 104 South York Road, Hatboro, PA, 19040, US

(21) Appl. No.: 12/756,291

(22) Filed: Apr. 8, 2010

Related U.S. Application Data
(60) Provisional application No. 61/168,247, filed on Apr. 10, 2009.

(51) Int. Cl. G06Q 90/00

(52) U.S. Cl. 705/500

(57) ABSTRACT

A fundraising method is presented including the sale of trays and trading cards, the latter exchanged between participants in a competitive fashion to complete a collection of cards so as to unlock a code or puzzle. Trays and trading cards include clues suggesting the proper placement of the cards onto the trays. The fundraising method includes selling a plurality of trays and trading cards from a fundraiser to a plurality of participants, exchanging the trading cards between participants, assembling the trading cards onto trays by participants, assisting participants to complete at least one tray with correctly assembled trading cards, and awarding a winner.

### CROSS REFERENCE TO RELATED APPLICATIONS

This application is based upon and claims priority from U.S. Provisional Application No. 61/168,247 filed Apr. 10, 2009 entitled Puzzle Based Fundraising Method, which is hereby incorporated in its entirety by reference thereto.

### FEDERALLY SPONSORED RESEARCH AND DEVELOPMENT

None.

### BACKGROUND OF THE INVENTION

1. Field of the Invention

The invention relates generally to a fundraising method implemented via the sale of trays and trading cards. Trading cards are exchanged by participants in a competitive manner to complete a collection of cards. A code or puzzle is deciphered when a complete set of cards is properly assembled along a tray. Trays and cards include clues suggesting the proper location of cards along the trays.

2. Background

Several devices and methods pertaining to fundraising are noteworthy from the related arts.

Parker, in U.S. patent application Ser. Nos. 11/473,333 and 11/431,098, describes puzzle devices and puzzle-based fundraising methods. Embodiments of the invention include a puzzle-based fundraising apparatus for use in fundraising activities. The apparatus includes at least one cell. Each cell has a pre-designated donation level. Furthermore, each cell having a unique donation level may include a unique initial cell appearance. The method may include implementing a multi-dimensional device having multiple cells. Each cell may represent a corresponding donation value. The method may additionally include obtaining a fundraising commitment for a donation value corresponding to a cell and associating the fundraising commitment with the corresponding cell.

Fass, in U.S. patent application Ser. Nos. 11/417,742 and 11/327,019, describes a fundraising board game for an organization including a board with indicia. The indicia corresponds to one or more donation values, wherein the indicia is disposed on a front surface of the board, wherein when the device is activated, the device supplies the indicia corresponding to the one or more donation values, and a user donates the one or more donation values to an organization. A method implemented by a fundraising system is also provided. The fundraising system includes at least one fundraising apparatus, at least one fundraising apparatus operator, and at least one donating person. The method includes receiving by the apparatus operator an amount of funds from a donating person, said amount corresponding to at least one resting location of a dial that is spun at least one time by the donating person, said resting location occurring after the dial has been spun by the donating person.

Hawkins, in U.S. Pat. No. 5,845,904, describes a cylindrical slide puzzle system including a cylindrical member, such as an open cylinder, cup or mug, having a slide puzzle incorporated with an outer cylindrical surface thereof. The slide puzzle includes a plurality of slide puzzle elements or pieces which are preferably arranged to form three horizontal rows between the top and bottom edges of the open cylindrical member, cup or mug, thus allowing for better fit as the slide puzzle elements proximate both the top and bottom are firmly held in place along at lease one side surface and a better fit is assured between the puzzle pieces.

As is readily apparent from the discussions above, the related arts do not include a fundraising method facilitated by trading cards arranged along a board so as to completely fill all spaces on the board and to solve a code or puzzle.

Therefore, what is required is a fundraising method facilitated by trading cards and trays whereby trading cards are arranged along a tray so as to completely fill all spaces on the tray to solve a code or puzzle.

### SUMMARY OF THE INVENTION

An object of the invention is to provide a fundraising method facilitated by trading cards and trays whereby trading cards are arranged along a tray so as to completely and correctly fill all spaces on the tray to solve a code or puzzle.

In accordance with embodiments of the invention, the fundraising method could include the following steps: selling trays and trading cards to participants by a fundraising group which could be a not-for-profit entity; trading or otherwise exchanging trading cards by and between participants; competing to be the first participants to complete a puzzle; assisting participants to identify winners; and awarding winners. Trays and trading cards are sold to the fundraiser by an administrator which could be a for-profit or other non-profit entity. The administrator could be compensated by sales of trays and puzzle packs to the fundraiser and optionally by receiving a portion of the profits realized by the fundraiser. The fundraiser's profits could be realized by marking up the price of the trays and puzzle packs paid by the participants. At least one participant within each themed category could receive a cash prize from the fundraiser for completing his or her tray and puzzle before others within the same group.

In accordance with other embodiments of the invention, the trading step could be performed within a forum which could be either manually or electronically implemented.

In accordance with other embodiments of the invention, a portion of proceeds from the selling step could be donated to a third party.

In accordance with other embodiments of the invention, each tray could include a plurality of identifiers each separately corresponding to one particular design disposed on a trading card so as to suggest the proper location of the trading card on a tray.

In accordance with other embodiments of the invention, each identifier could be a clue which could be presented in a question-like format.

In accordance with other embodiments of the invention, each trading card could include at least one symbol whereby a plurality of symbols form a code when a plurality of trading cards is properly placed onto and completing a tray.

In accordance with other embodiments, each symbol could be a letter, a number, or a design in part or whole.

In accordance with other embodiments of the invention, the trading cards could include designs and/or words consistent with one or more specific themes.

In accordance with other embodiments of the invention, each tray could include indicia identifying a sponsor.

In accordance with other embodiments of the invention, the award step could include a monetary prize or gift or a non-monetary prize or gift, the latter including but not limited to a dinner, a party, a plaque or a certificate.

In accordance with other embodiments of the invention, the award step could have a sponsor purchasing a tray with trading cards from a winner.

In accordance with other embodiments of the invention, the trading cards and/or trays could include a plurality of designs with multiple copies of each design.

In accordance with other embodiments of the invention, the number of copies for at least one design for the trading cards is less than the number of copies for each of the other designs.

In accordance with other embodiments of the invention, the fundraising method could include selling a plurality of trays and a plurality of trading cards to a plurality of participants, facilitating the exchange of trading cards between participants, and placing trading cards onto a tray to assemble a hidden code.

In accordance with other embodiments of the invention, the participants are assisted so as to ensure identification of at least one winner.

In accordance with other embodiments of the invention, at least one participant receives an award for unlocking a hidden code or puzzle.

In accordance with other embodiments of the invention, the trading cards could include at least one rogue card.

The fundraising method is implemented via a puzzle-like device which could include a theme-based tray and non-interlocking trading cards. Puzzle devices are marked or coded to identify the fundraising activity or fundraiser. Each player or participant separately purchases a tray and trading cards. Trading cards could be sold in package form including one or more cards. Each player is required to purchase at least one pack, preferably two or more. In some embodiments, each player places theme-based trading cards within a similar themed tray to complete the puzzle and reveal an encoded message along the surface thereof. The object is to complete the puzzle before other players. The quantity of one or more trading cards within a themed category is limited to reduce the number of potential winners.

The method of play requires participants to trade cards to complete a collection of cards which correctly fill all spaces along a tray. It is understood that the term trade is used interchangeably with other terms whereby a card is passed from one party to another party with or without ownership rights, examples including, but not limited to, exchanging, bartering, collecting, selling, lending, and borrowing. One or more card designs are limited to restrict the number of completely fillable trays.

Each tray could include clues and puzzles for the participant to research and solve so as to correctly identify placement of cards along a tray. Further, the play method could require a participant to properly assemble trading cards on a single tray to decipher a hidden code. The play method could also require participants to identify, discard, or otherwise trade rogue cards which prevent or frustrate completion of the code. The play method is not just a competition, but could also functions as a learning tool through which participants find and acquire information to properly solve clues and puzzles. The play method could require the participants to engage in a variety of activities including bartering, trading, negotiating, and problem solving.

The device and method of play facilitate a fundraising method for non-profit organizations, examples including, but not limited to, schools, religious organizations, sports teams, and civic groups. In a first selling step, an administrator could sell trading cards and board-like trays to a fundraiser. In a next selling step, the fundraiser could sell trading cards and trays to participants, namely, students, children, families, and the like. In a trading step, participants could trade and share trading cards so as to secure cards required to completely fill the identified spaces within one or more trays. In a competing step, each participant could place trading cards onto his or her tray to completely fill the spaces within the tray. In an assisting step, the administrator could assist the participants to identify completed game boards. Participants who complete his or her game board then could sell the completed game board to the fundraiser or a sponsor thereof and allow the fundraiser or sponsor to display the completed tray along with the participant's name and photograph.

The described invention provides advantages over the related arts. The invention facilitates a children-centric fundraiser method enabling both game play and fundraising for a variety of beneficiaries including, but not limited to, schools, organizations, individuals, families, groups, charities, or causes, the latter further including, but not limited to, autism, diabetes, and cystic fibrosis. The fundraising method includes educational aspects allowing participants to better develop an understanding of a topic with life long implications, examples including, but not limited to, the environment, conversation, recycling, agriculture, energy, health, and diet. The invention reinforces a child's sense of accomplishment, self worth, responsibility, and achievement.

The above and other objectives, features, and advantages of the preferred embodiments of the invention will become apparent from the following description read in connection with the accompanying drawings, in which like referenced numerals designate the same or similar elements.

### REFERENCE NUMERALS

1-6 Step 23 Recess
7 Administrator 24 Flap
8 Fundraiser 25 Base
9 Participant 26 Electronic trading forum
10 Winning Participant 27 Manual trading forum
11 Third party 28 Participant
12 Tray 29 Identifier field
13 Trading card 30 Identifier
14 Play area 31 Tray
15 Code 32 Card field
16 Joint 33 Clue
17 Symbol 34 Identification field
18 Security field 35 Indicia
19 Border 36 Endorsement field
20 Design 37 Trading card
21 Front face 38 Symbol
22 Back face

### BRIEF DESCRIPTION OF THE INVENTION

Additional aspects, features, and advantages of the invention will be understood and will become more readily apparent when the invention is considered in the light of the following description made in conjunction with the accompanying drawings.

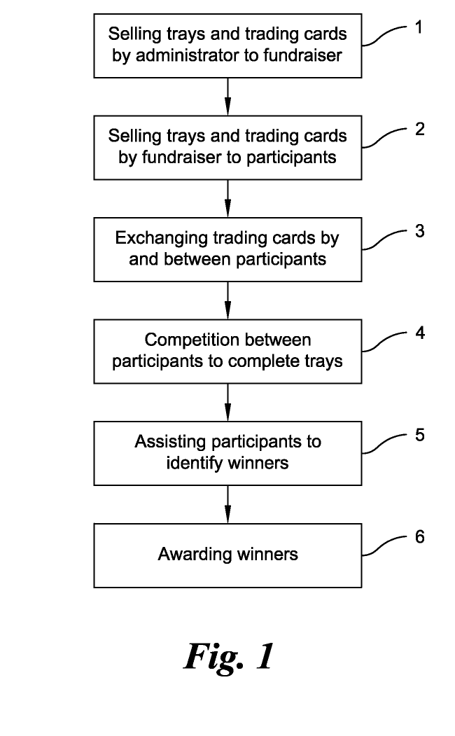

FIG. 1 is a flowchart illustrating a fundraising method implemented with trays and trading cards in accordance with one embodiment of the invention.

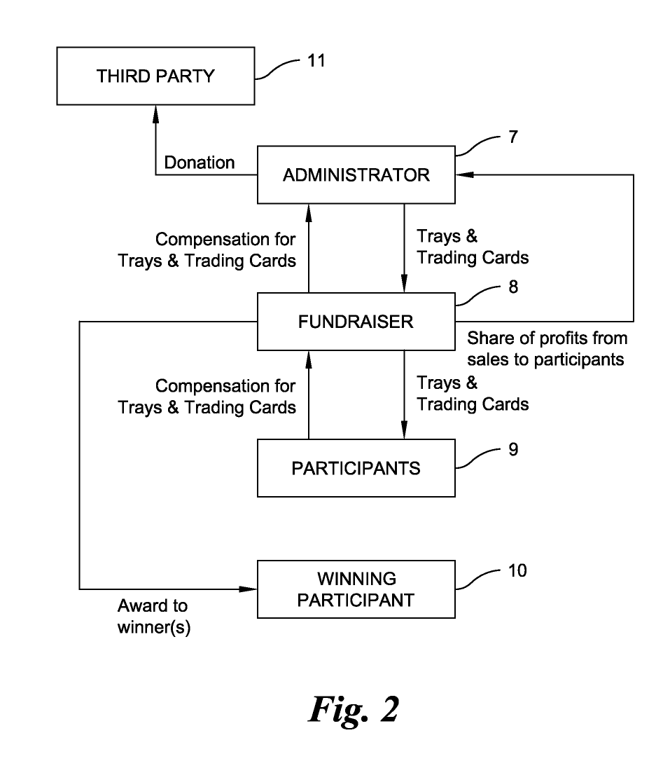

FIG. 2 is a flowchart illustrating interaction between various parties during the implementation of the puzzle-based fundraising method in accordance with one embodiment of the invention.

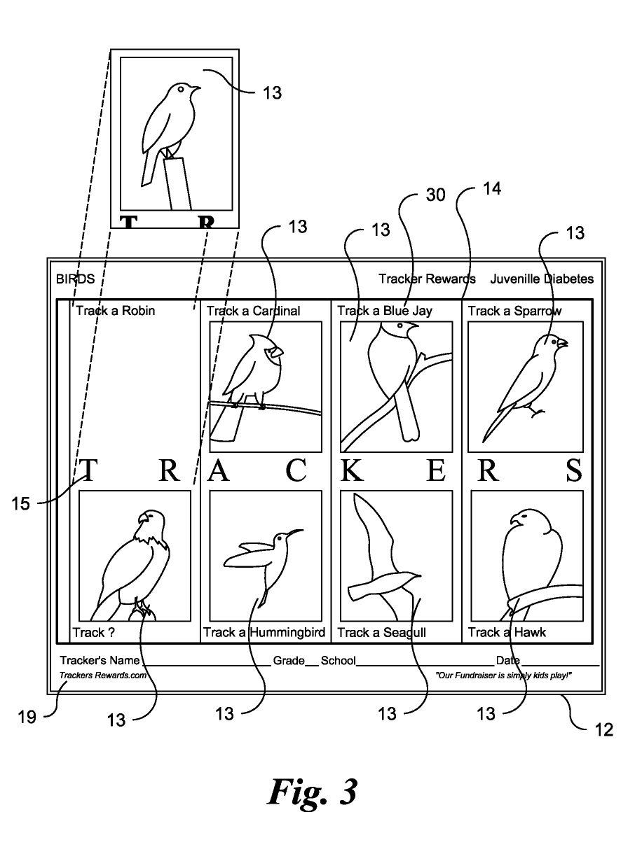

FIG. 3 is a top plan view illustrating a tray and trading cards with theme-based designs in accordance with one embodiment of the invention.

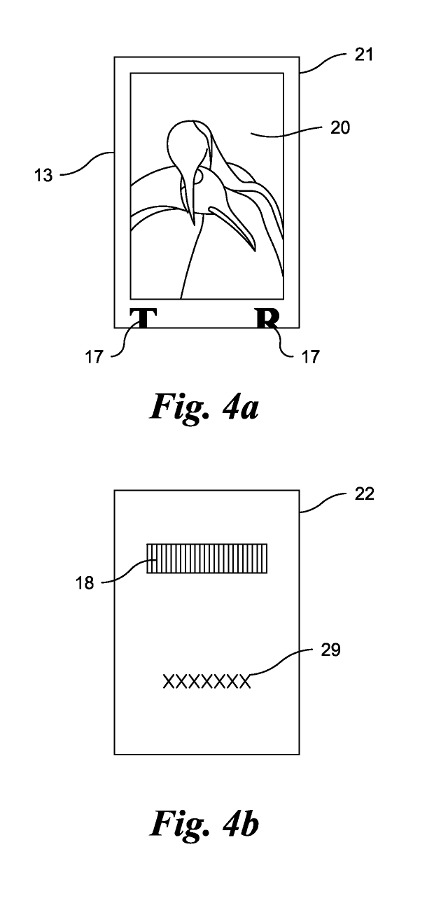

FIG. 4a is a top plan view illustrating the front face of a trading card with design and symbols in accordance with one embodiment of the invention.

FIG. 4b is a bottom plan view illustrating the back face of a trading card with design and security and identification indicia in accordance with one embodiment of the invention.

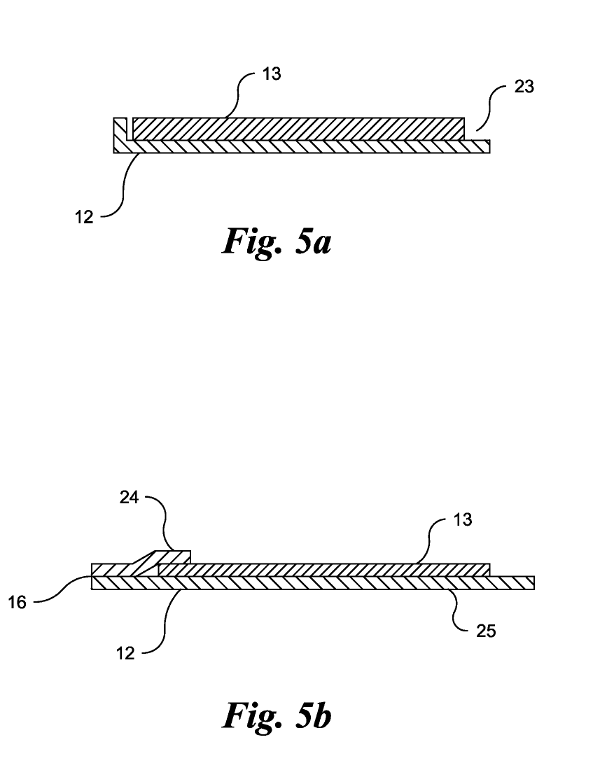

FIG. 5a is a cross section view illustrating a trading card recessed within a game tray in accordance with one embodiment of the invention.

FIG. 5b is a cross section view illustrating a trading card secured along one edge of a tray via a flap-like structure.

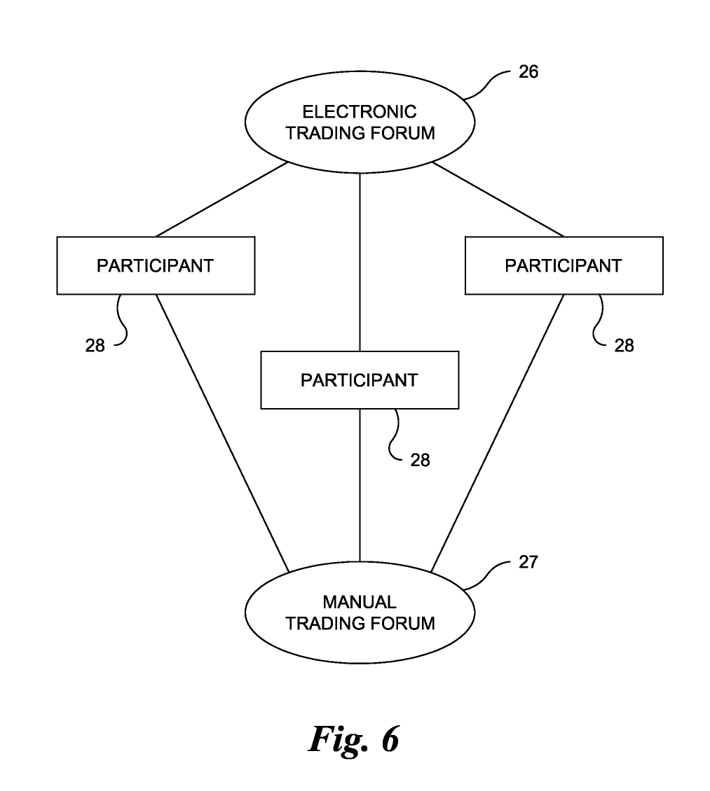

FIG. 6 is a flowchart illustrating interaction between multiple participants and forums facilitating the exchange of trade cards in accordance with one embodiment of the invention.

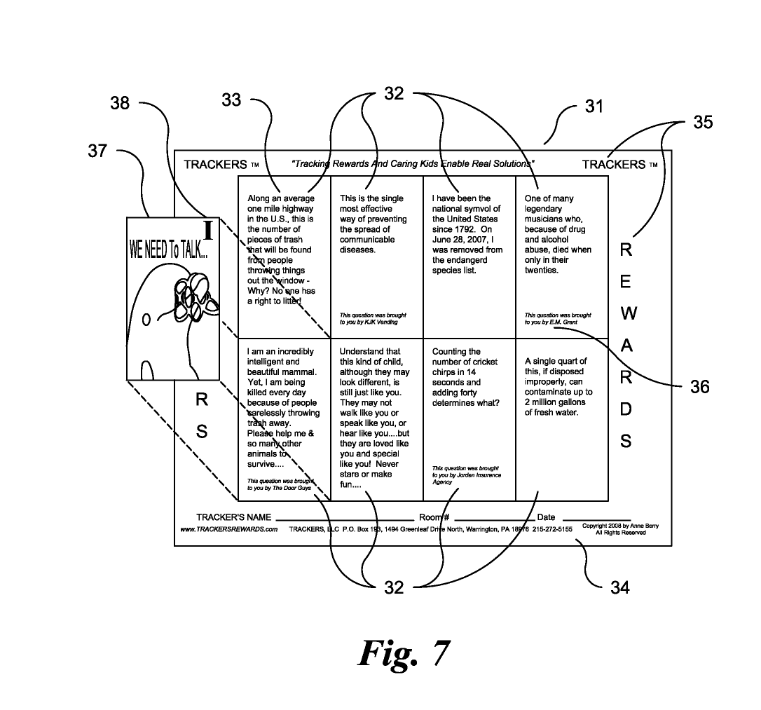

FIG. 7 is a top plan view illustrating a tray with multiple queries and trading cards with designs, images, and/or words representing a match or answer to each specific query in accordance with one embodiment of the invention.

### DETAILED DESCRIPTION OF THE INVENTION

Reference will now be made in detail to several preferred embodiments of the invention that are illustrated in the accompanying drawings. Wherever possible, same or similar reference numerals are used in the drawings and the description to refer to the same or like parts. The drawings are not to precise scale. While various features and steps are separately described herein, it is understood that two or more such features and/or steps could be combined into a single embodiment.

Referring now to FIGS. 1-2, the fundraising method could include a variety of steps. In the first selling step 1, an administrator 7 sells trays 12 and trading cards 13 to a fundraiser 8. In another selling step 2, the fundraiser 8 sells the same trays 12 and trading cards 13 to participants 9. The sales price of trays 12 and trading cards 13 in the second selling step 2 includes a markup representative of the funds raised by the fundraiser 8. In the trading step 3, participants 9 trade or otherwise transfer trading cards 13 so as to secure trading cards 13 required to completely fill the identified spaces along their respective trays 12. In the competing step 4, each participant 9 places trading cards 13 onto his or her tray 12 until all spaces are completely filled within the tray 12. In the assisting step 5, the administrator 7 assists participants 9 to identify one or more winning participants 10. A winning participant 10 is a participant 9 who completes his or her puzzle before other participants 9. Winning participants 10 receive a gift or prize from either the administrator 7 or fundraiser 8 in the awarding step 6. The gift or prize could include, but not limited to, money, savings bond, or other money-based award or a dinner, party, plaque, certificate or other non-monetary based award or recognition.

The fundraiser 8 could be a not-for-profit entity, examples including, but not limited to, schools, religious organizations, sports teams, and civic groups. The administrator 7 could be a for-profit or not-for-profit entity. Participants 9 could include, but not limited to, students, children, families, and the like.

In some embodiments, the administrator 7 or fundraiser 8 could donate a portion of payments made by the fundraiser 8 to the administrator 7 to a third party 11. The third party 11 could include a not-for-profit group or organization identified as the recipient of a donation by the fundraiser 8. Payments from the fundraiser 8 to administrator 7 could include compensation in the first selling step 1 and a portion of the markup or profits from proceeds received by the fundraiser 8 from participants 9 in the second selling step 2.

Trays 12 and trading cards 13 are sold to a fundraiser 8 by an administrator 7. The administrator 7 is compensated by sales of the trays 12 and trading cards 13 to the fundraiser 8 and might receive a portion of the profits realized by the fundraiser 8. Profits of the fundraiser 8 are realized by marking up the price of the trays 12 and puzzle packs 13 paid by the participants 9. At least one participant 9 within each themed category could receive a cash prize from the fundraiser 8 or administrator 7 for completing his or her tray 12 before others within the same themed category or all such categories. In some applications, it might be difficult for participants 9 to complete one or more trays 12. In such cases, the administrator 7 could provide one or more facilitators, examples including, but not limited to, an employee, volunteer, sub-contractor, or agent, to work with the participants 9 so as to encourage game play resulting in the completion of trays 12 and identification of winners.

Referring now to FIGS. 3, 4a, and 4b, an exemplary tray 12 and several exemplary trading cards 13 are shown. Trays 12 and trading cards 13 could be separately purchased. Trays 12 and trading cards 13 could include a variety of themes, examples including, but not limited to, math, science, history, geography, objects, events, famous persons, plants, animals, words, phrases, and quotes. The difficulty and challenge offered by the method of play increases with the number of themes and/or themed-based categories sold by a fundraiser 8, the number of trading cards 13 required to complete a tray 12, and the number of rogue trading cards 13 which frustrate the completion of trays 12.

Each tray 12 includes a play area 14 and a border 19. The play area 14 is sufficiently large so as to allow for the placement of trading cards 13 therein. For example, FIG. 3 shows a play area 14 with eight spaces accommodating eight trading cards 13 arranged in a two by four configuration. However, it is understood that the play area 14 could be sufficiently sized so as to accommodate any number of trading cards 13. The play area 14 could also include a code 15, examples including, but not limited to, a word or phrase composed of letters, numbers, designs or symbols, printed or otherwise disposed thereon. The border 19 could include indicia used to identify the tray 12, participant 9 and/or fundraiser 8. Trays 12 are preferred to be theme-based and include identifiers 30 which reference events, persons, animals, plants, objects, or any other set which could be grouped into a common class or category. For example, FIG. 3 includes identifiers 30 which reference birds. The location of each identifier 30 corresponds to the locations onto which the matching trading card 13 is properly placed. In some embodiments, a tray 12 could include two or more themed categories.

Referring again to FIG. 4a, the front face 21 of a trading card 13 is shown including a design 20 and a pair of symbols 17. The design 20 allows the trading card 13 to be matched with an identifier 30 on a tray 12. For example, a design 20 could include a picture, drawing, image, and/or one or more words. The symbol 17 could correspond to portions of the code 15 within the play area 14. In other embodiments, the code 15 might only be visible after all trading cards 13 with corresponding symbols 17 are properly assembled onto a tray 12. A symbol 17 could include a letter or number or portions thereof. One or more symbols 17 could appear on a single trading card 13. Placement of the trading card 13 onto the play area 14 must match the identifier 30 and could properly correspond to the code 15 within the placement area. In some embodiments, at least two trading cards 13 are required to complete one or more letters, numbers, or designs comprising the code 15. In other embodiments, it may be advantageous to have rogue trading cards 13 which properly match one or more identifiers 30, but not allow the symbol 17 to match the letters, numbers, or designs within the code 15.

Referring now to FIG. 4b, trading cards 13 could include a security field 18 which appears on the back face 22 of each trading card 13 to prevent counterfeiting or the like. The security field 18 could include a watermark, alphanumeric series, hologram, bar code, or other difficult to duplicate marking. Likewise, it is desired for each trading card 13 to include an identifier field 29 which restricts use of the trading card 13 to the fundraising activities of a single fundraiser 8.

Each tray 12 and trading card 13 may be composed of cardboard, wood, plastic, or other durable material. Referring now to FIG. 5a, the play area 14 could include one or more recesses 23 which allow for the secured placement of trading cards 13 onto the tray 12. Alternatively, the tray 12 could include a rigid or semi-rigid base 25 and have one or more bendable flaps 24 disposed about its perimeter which allow a participant 9 to secure trading cards 13 to the tray 12, as represented in FIG. 5b. In the latter embodiment, the bendable flap 24 could be adhesively bonded or mechanical fastened to the base 25 along a joint 16. A trading card 13 is inserted between the base 25 and flap 24 is a sliding fashion and pinched or grasped there between.

Each participant 9 separately purchases a tray 12 and trading cards 13. Trading cards 13 could be sold in packs of two or more. Each participant 9 could be required to purchase more than one pack to participate in the fundraising effort. Each participant 9 collects the theme-based trading cards 13 which correspond to his or her tray 12 by trading or sharing trading cards 13 with other participants 9. Trading cards 13 which correspond to a tray 12 are placed onto and secured thereto to match the identifiers 30 and allow for the completion of the code 15 via the alignment of symbols 17.

The number of trading cards 13 required to complete a tray 12 is game dependent. For example, the tray 12 shown in FIG. 3 requires eight trading cards 13 to complete the challenge. However, it might be advantageous to require more than eight such pieces for game play to increase the difficulty of the game and total funds raised thereby. The object of the challenge is to complete to completely and properly fill the play area 14 with trading cards 13 so as to complete the game.

To limit the number of potential winners, the quantity of one or more trading cards 13 within one or more themed categories could be limited. The number of trading cards 13 could allow for at least one winner capable of completely and correctly filing the spaces on his or her tray 12. Limitations on the number of trading cards 13 require the participants 9 to trade unwanted trading cards 13 so as to secure those pieces required to complete a tray 12.

Referring now to FIG. 6, trading and sharing activities could include both manual and electronic means. For example, participants 28 could trade and share trading cards 13 in a manual trading forum 27 which could include a school yard during recess, while walking home from school, or activities at a party or gathering. Participants 28 might also trade and share trading cards 13 in an electronic trading forum 26 which could include communication means over the Internet or a website specifically dedicated to such activities. Also, tray 12 and trading cards 13 could be purchased directly from the fundraiser 8 over the Internet.

The following example describes one possible method of play to illustrate the features of the invention. The description is not intended to limit or otherwise constrain the overall scope of the invention.

Participants 9 could purchase one of twelve trays 12 with different themes. Each themed group could include a total of fifty trays 12. Each tray 12 could require the proper placement of eight trading cards 13 for completion. Participants 9 could purchase trading cards 13 bundled in packs of three trading cards 13. Accordingly, each participant 9 would be required to purchase at least three packs of trading cards 13 to potentially win. Packs would include trading cards 13 from the twelve different themed categories. The total number of trading cards 13 for one or more designs within each themed group could be limited to one so as to allow for only twelve winners, representing a two percent chance of winning.

One theme could include birds. The corresponding trays 12 could identify eight birds, examples including a Robin, Cardinal, Blue Jay, Finch, Bald Eagle, Hummingbird, Seagull, and Hawk. Trading cards 13 could be sold showing images of the referenced birds. Additional birds could appear on the trading cards 13 to complicate play. For example, a ninth trading card 13 having the image of a Pigeon could be included, but not match any identifier 30 on the trays 12 or match an identifier 30 but not properly complete the code 15. The number of trading cards 13 showing a Bald Eagle could be limited to one so as to allow for only one winner within the themed category.

The period of play could be limited to a specified time period including hours, days, weeks, or months or an unspecified period allowing all trading cards 13 to be sold and/or winners identified. At the end of the play period, facilitators could be sent to interact with participants 9 to review trading cards 13 and trays 12 which are partially completed. The facilitators could ensure that all trading cards 13 which are limited in number and required to win are utilized by participants 9 to expedite winners. Upon conclusion of the fundraising effort, trays 12 with trading cards 13 are retained as a decorative reminder of the event.

Referring now to FIG. 7, an exemplary tray 31 is shown including a plurality of card fields 32 for use with the fundraising method described herein. Each card field 32 could include a clue 33 in the form of a question. Each clue 33 could correspond to a single trading card 37 and/or design therefore. Each trading card 37 could include a design which properly answers or corresponds to the clue 33 and a symbol 38 used to construct a code 15. The tray 31 could further include indicia which identify the game, fundraiser 8, or other information to promote sales of trays 31 and trading cards 37. An identification field 34 could be provided along one side of the tray 31 allowing a participant 9 to identify his/her name and other pertinent information. Indicia 35 or other markings could appear along the tray 31. The tray 31 or card fields 32 could include an endorsement field 36 that allows the fundraiser to promote sponsors and other parties who contributed supplementary funds to the fundraiser 8.

The description above indicates that a great degree of flexibility is offered in terms of the invention. Although various embodiments have been described in considerable detail with reference to certain preferred versions thereof, other versions are possible. Therefore, the spirit and scope of the appended claims should not be limited to the description of the preferred versions contained herein.

What is claimed is:

1. A fundraising method comprising the steps of:
(a) selling a plurality of trays and a plurality of trading cards to a fundraiser;
(b) selling said trays and said trading cards by said fundraiser to a plurality of participants;
(c) trading said trading cards between said participants;
(d) assembling said trading cards onto said trays by said participants;
(e) assisting said participants to identify at least one winner having completely and correctly assembled said trading cards onto one said tray; and
(f) awarding said at least one winner.

2. The fundraising method of claim 1, wherein said trading step is performed within a forum.

3. The fundraising method of claim 1, further comprising the step of:
(g) donating a portion of proceeds from said selling step to a third party.

4. The fundraising method of claim 1, wherein each said tray includes a plurality of identifiers each separately corresponding to one said trading card so as to suggest the proper location of each said trading card on said tray.

5. The fundraising method of claim 1, wherein each said identifier is a clue.

6. The fundraising method of claim 1, wherein said clue is a question.

7. The fundraising method of claim 1, wherein each said trading card includes at least one symbol whereby a plurality of symbols form a code when said trading cards are properly placed onto and completing one said tray.

8. The fundraising method of claim 7, wherein each said symbol is in part or whole a letter, a number, or a design.

9. The fundraising method of claims 1, wherein said trading cards are themed.

10. The fundraising method of claim 1, wherein each said tray includes at least one sponsor marking.

11. The fundraising method of claim 1, wherein said awarding step includes a monetary prize or gift or a non-monetary prize or gift.

12. The fundraising method of claim 11, wherein said non-monetary prize or gift is a dinner, a party, a plaque or a certificate.

13. The fundraising method of claim 1, wherein said awarding step includes purchasing said tray and said trading cards from said at least one winner.

14. The fundraising method of claim 1, wherein said trading cards include a plurality of designs with multiple copies of each said design.

15. The fundraising method of claim 14, wherein the number of copies for at least one of said designs is less than the number of copies for each of the remaining said designs.

16. The fundraising method of claim 1, wherein said trays include a plurality of designs.

17. The fundraising method of claim 1, wherein said trading cards include at least one rogue card.

18. A fundraising method comprising the steps of:
(a) selling a plurality of trays and a plurality of trading cards to a plurality of participants;
(b) facilitating exchange of said trading cards between said participants; and
(c) placing said trading cards onto said tray by each said participant to assemble a code.

19. The fundraising method of claim 18, further comprising the step of:
(d) assisting each said participant to identify at least one winner.

20. The fundraising method of claim 18, further comprising the step of:
(d) awarding at least one said participant for unlocking said code.
